(19) United States
(12) Patent Application Publication
(10) Pub. No.: US 2008/0067301 A1
(43) Pub. Date: Mar. 20, 2008

(54) Display stand stabilizing pedestal

(76) Inventors: Geoffrey Alan Moss, Maple (CA); David Brian Minister, Maple (CA)

Correspondence Address: DAVID W. WONG, 46 WILLOWBROOK ROAD, THORNHILL, ON, L3T 4W9, US

(21) Appl. No.: 11/520,824

(22) Filed: Sep. 14, 2006

(51) Int. Cl. F16M 11/00; A45D 19/04

(52) U.S. Cl. 248/174

(57) ABSTRACT

A pedestal formed with a foldable pattern provided on a sheet material is mountable to either the base portion or at a raised position of the front panel of a display stand to provide a horizontal platform for supporting a merchandise case placed on the stand. It also increases the stability of the stand against tipping under the weight exerted on its front panel by the merchandise case with merchandise located therein. The pedestal is provided with mounting tabs which are engageable with mounting slot openings in the front panel of the stand and it may either be detachably or permanently mounted to the stand.

### BACKGROUND OF THE INVENTION

1. Field of the Invention

This invention relates to a pedestal mountable to the front surface of a display stand for supporting a merchandise display case placed on the stand as well as providing stability for the stand in supporting the display case and more particularly to a pedestal for a display stand having a front panel slanted rearward. The pedestal may be mounted detachably or undetachably to the stand selectively.

2. Background Art

Display stands particularly cardboard display stands are commonly used for supporting a merchandise case or tray mounted to their front panel. The stand usually has a front panel slanted rearward at the top to provide stability in supporting the weight of the merchandise. In order to provide better stability to the stand such that it would not topple over forward due the weight of the merchandise a rectangular casing is integrally formed at the base of the front panel of the stand not only to increase its stability but also to provide a pedestal for supporting a merchandise display case placed on or mounted to the stand. Due to the complexity of the construction of the integral stabilizer and pedestal, the stand is difficult to fabricate and it is unwieldy and awkward to erect. Some display stands provide a separate rectangular weight supporting box placed in front of its base for supporting the merchandise tray located on the box and leaning on the front panel of the stand. The box may or may not be attached to the stand. Such arrangement is problematic since the weight of the merchandise in the display case would tend to push the stand and rectangular supporting box to separate from one another thus rendering the stand unstable. The supporting box requires a large amount of cardboard and a larger stamping die to fabricate. Furthermore, supporting boxes of various heights must be provided to support the merchandise display case to locate at various heights on the front panel of the display stand.

### SUMMARY OF THE INVENTION

It is a principal object of the present invention to provide a pedestal which may be mounted to the front panel of a display stand to provide a support of a merchandise display case placed thereon as well as to provide an increase stability for the stand.

It is another object of the present invention to provide a pedestal formed by stamping a pattern on a single sheet of cardboard or corrugated material and the like.

It is another object of the present invention to provide a pedestal which is selectively detachable or fixedly mounted to the display stand.

It is another object of the present invention to provide a pedestal which forms an integral part of the display stand.

It is yet another object of the present invention to provide a pedestal which may be folded to a collapsed condition with the display stand to facilitate easy erection of the display stand.

It is still another object of the present invention to provide a pedestal which supports a merchandise display case at a select level above the floor on which the display stand is resting yet provides increased stability for the stand without increasing the foot print of the latter.

### BRIEF DESCRIPTION OF THE DRAWINGS

In the drawings

FIGS. 1 and 2 show a prior art display stand with a separate rectangular support box placed in front of its base for supporting a merchandise case.

FIG. 3 is a perspective front and left side elevation view of a display stand with the pedestal according to the present invention mounted to base portion of its front panel.

FIG. 4 is an exploded elevation view of showing the assembly of the pedestal to the display stand.

FIG. 5 is a perspective top elevation view of the pattern of the pedestal formed on a single piece of sheet material.

FIG. 6 is an enlarged isolated partial sectional side elevation view showing the engagement of the mounting tab of the pedestal with the front panel of the display stand.

FIG. 7 is an enlarged isolated partial sectional rear view of the front panel of the display stand showing the bending of the hook portion of the mounting tab prior to inserting into the mounting opening of the front panel of the display stand for fixedly mounting the pedestal to the stand.

FIG. 8 is a perspective top elevation view of an alternative pattern of the pedestal formed on a single piece of sheet material in which the mounting hook has a butterfly shape.

FIG. 9 is an enlarged isolated partial sectional side elevation view showing the engagement of the butterfly mounting hook with the mounting opening of the front panel of the display stand.

FIG. 10 is an enlarged isolated partial sectional rear view of the front panel of the display stand showing the bending of the arm portions of the mounting hook prior to inserting it into the mounting opening of the front panel of the display stand for fixedly mounting the pedestal to the stand.

FIG. 11 is a perspective front and side elevation view showing an alternative pedestal according to the present invention mountable at a selected height to the front panel of the display stand for supporting a merchandise display case at such level above the ground as well as increasing the stability of the stand without increasing its footprint.

FIG. 12 is a perspective front and side elevation view showing the formation of mounting openings on the front panel of the display stand for mounting the alternative pedestal of FIG. 11.

FIG. 13 is a perspective front elevation view of the pattern stamped on a single sheet material for forming the alternative pedestal of FIG. 11.

FIG. 14 is an enlarged isolated partial sectional elevation view showing the engagement of the mounting hook and tab of the alternative pedestal with the mounting openings of the display stand.

### DETAILED DESCRIPTION OF THE PREFERRED EMBODIMENTS

With reference to the drawings, a merchandise case 10 is placed on top of a separate rectangular supporting box 11 located in front of the base of the front panel 12 of a display stand 13. The construction is unstable and may cause the merchandise case 10 to fall from the stand.

According to the present invention, a foldable support pedestal 14 may be mounted to the base portion of the front panel 15 of a display stand 16. A display stand having a side sectional triangular shape is shown as an example. It can be understood by those skilled in the art that the pedestal 14 may be mounted to any vertical display stand such as a single planar board display stand supported by an easel, or a display stand having two display panels sloping in a divergent manner from top to bottom, for the same purposes. The support pedestal 14 may be constructed by stamping a pattern 17, as best shown in FIG. 5, on a sheet material such as cardboard or corrugated material. The pattern 17 consists of a central panel 18 having two side panels 19 and 20 which are foldable relative to the central panel 18 along vertical fold lines 21 and 22 respectively. Two mounting hooks 23 and 24 are formed at the outer edges 25 and 26 of the side panels 19 and 20 respectively. The mounting hooks 23 and 24 may be in the form of a reverse L shape and have a vertical downward extending arm portions 27 and 28 respectively. A generally rectangular panel 29 is located above the central panel 18 and it is foldable relative to the central panel along horizontal fold line. A mounting tab 31 is formed at the top free edge 32 of the rectangular panel 29.

The pedestal may be mounted to a display stand having two vertical mounting slot openings 33 and 34 formed adjacent to its side edges 35 and 36. The mounting slot openings 33 and 34 are sized to receive the mounting hooks 23 and 24 of the support pedestal 17 respectively, and they are located at the same height from the bottom edge of the front panel 15 as the height of the mounting hooks 23 and 24 from the bottom edge of the side panels 19 and 20 respectively. A horizontal mounting slot opening 37 is formed in the front panel 15 of the display stand 16. The horizontal mounting slot opening 37 is spaced from the bottom edge of the display stand as the height of the distance between the horizontal fold line 30 and the bottom edge of the central panel 18 of the support pedestal 17.

The support pedestal 17 may be readily mounted to the front panel 15 of the display stand 16 by folding its side panels 19 and 20 rearwards to locate parallel to the vertical side edges of the display stand 17 and then slidably inserting the mounting hooks 23 and 24 into the vertical mounting slot openings 33 and 34 respectively of the display stand such that the extension arm portions 27 and 28 will latch with the lower edge portion of the mounting slot openings 33 and 34 respectively as best shown in FIG. 6 to maintain the support pedestal 17 securely mounted to the front panel 15 of the display stand 16. The rectangular panel 29 may then be folded rearwardly downwards to the horizontal position so that the mounting tab 31 will engage with the horizontal mounting slot opening 37 of the front panel 15 of the display stand for maintaining the rectangular panel 29 is a mounted position perpendicular to the front panel 15 so as to provide the required platform or pedestal top for supporting a merchandise display case placed onto the display stand 16 as shown in FIG. 2. The merchandise display case may additionally be mounted to the display stand 16 with mounting hooks (not shown) slidably mounted between the top edge of the display stand and slots formed at the rear panel of the merchandise display case.

The support pedestal 17 once mounted forms an integral part of the display stand 16, which provides a platform for supporting the merchandise display case with the merchandise located therein. It also increases the stability of the display stand against tipping forward due to the increased dimensions or footprint of the base of the display stand.

Two vertical foldable lines 38 and 39 may be formed at the middle of the side panels 19 and 20 respectively such that the side panels 19 and 20 may flex inward or outward to provide additional support to increase further the stability of the display stand. The support pedestal 17 may be detached from the display stand 16 in the reverse order by first disengaging the mounting tab 31 and then disengaging the mounting hooks 23 and 24 from the vertical mounting slot openings 33 and 34 of the display stand.

The support pedestal 17 may also be folded to a collapsed condition along the vertical foldable lines 38 and 39 together with the display stand 16 folded to a collapsed condition to form a totally collapsed composite body which may be erected by simply unfolding the display stand and the pedestal in the reverse order. The collapsed display stand and support pedestal composite body facilitate convenient transportation and storage with the merchandise display case.

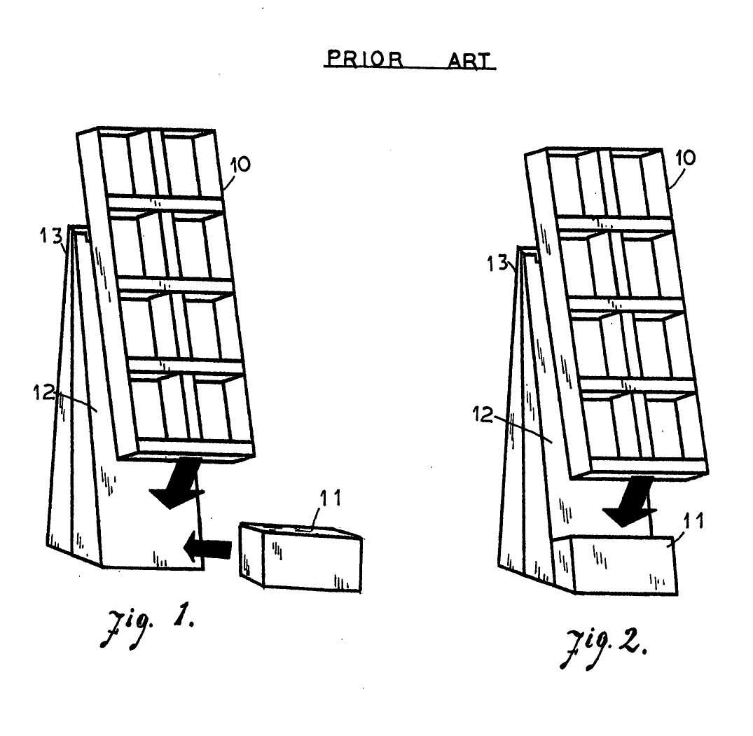

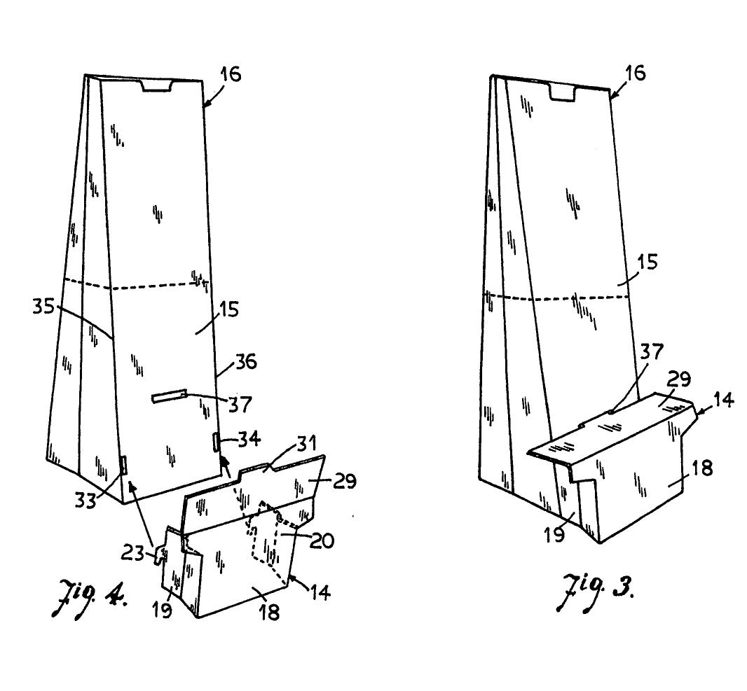

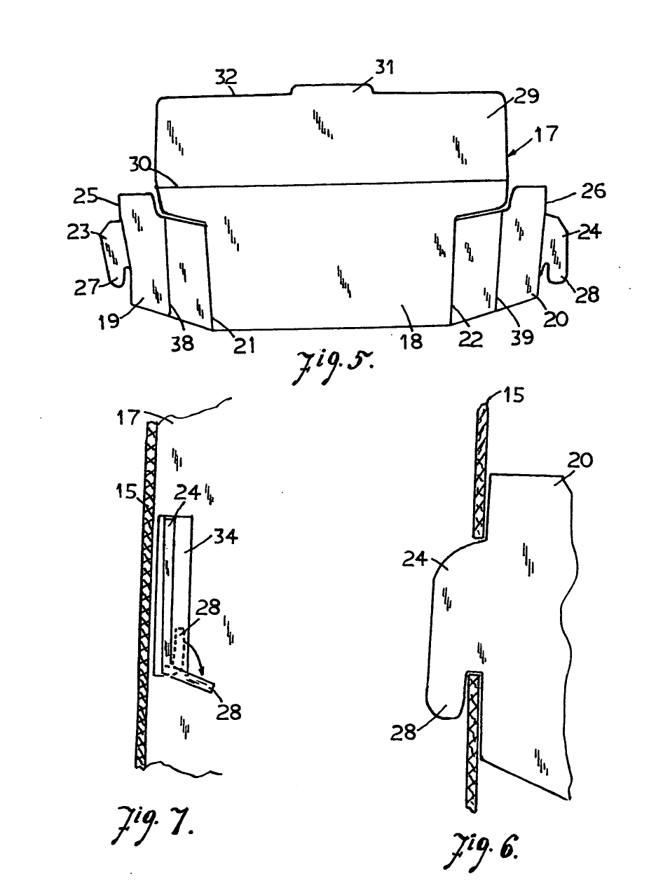

As best shown in FIG. 7, the extension arm portions 27 and 28 of the mounting hooks 23 and 24 of the support pedestal 17 may be folded to lie juxtaposed to the main body of the mounting hooks 23 and 24 respectively prior to being inserted into the vertical mounting slot openings 33 and 34 of the display stand 16. In so doing, after the mounting hooks 23 and 24 have been inserted into the mounting slot openings 33 and 34 the extension arm portions 27 and 28 will unfold inherently from the mounting hooks 23 and 24 respectively due to the characteristic of the cardboard or corrugated board material so as to form latches for permanently and securely mounting the pedestal 17 to the display stand 16.

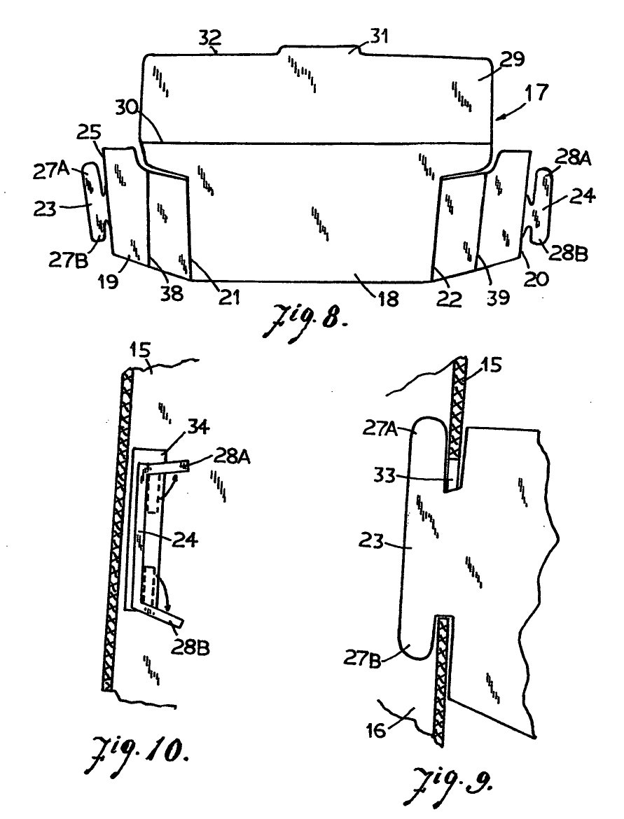

An alternative embodiment of the support pedestal 17 is shown in FIG. 8. In this embodiment, the mounting hooks 23 and 24 has a butterfly or T shape having extension arm portions 27A and 27B, and 28A and 28B respectively as shown. The mounting openings 33 and 34 formed on the front panel 15 of the display stand are longer than that of the embodiment described above such that the T shape mounting hooks 23 and 24 may engage with the mounting openings 33 and 34 slidably by slidably inserting the top extension arm portions 27A and 28A into the mounting openings 33 and 34 first and then pushing the mounting hooks 23 and 24 upwards to insert the lower extension arm portions 27B and 28B into the mounting openings until the lower edge of the mounting hooks 23 and 24 rest on the lower edge of the mounting openings 33 and 34 while the upper extension arm portions 27A and 28A will latch against the upper edge portion of the mounting openings 33 and 34 respectively to retain the pedestal 17 securely mounted in place to the front panel of the display stand. The butterfly shape mounting hooks 23 and 24 prevent the pedestal from accidentally disengaging from the mounted position. The extension arm portions 27A, 27B, 28A and 28B may be folded against the main body of the mounting hooks 23 and 24 similar to that in the previous embodiment prior to being inserted into the mounting openings 33 and 34 such that they would inherently turn to a crosswise position across the mounting openings 33 and 34 after insertion to retain the pedestal 17 permanently mounted to the display stand 16.

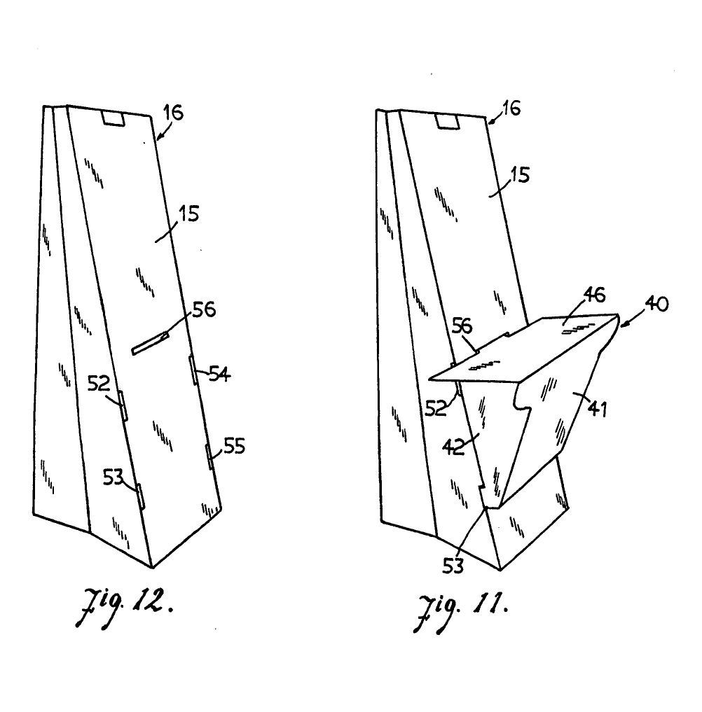

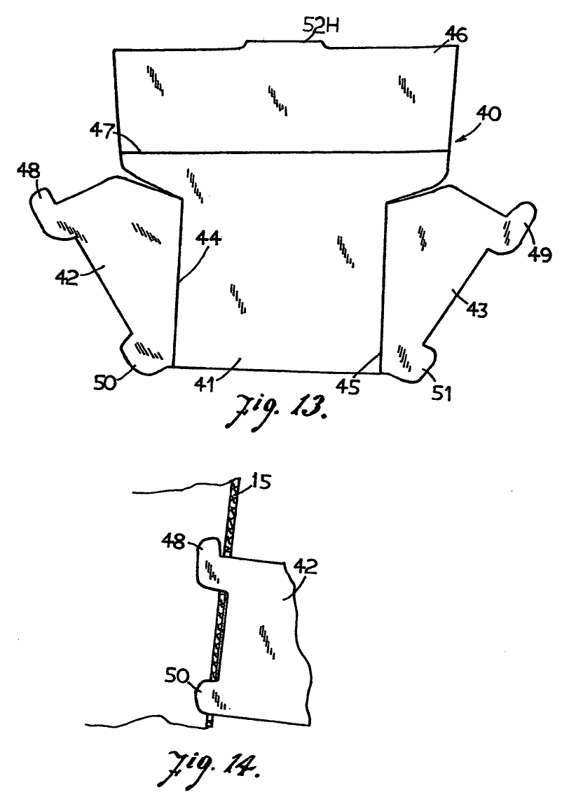

The pedestal according to the present invention may alternatively be mounted at a raised position above the floor as shown in FIG. 10 to provide a support for the display case at such level as well as to provide stability for the display stand against toppling without increasing the footprint of the display stand. The pedestal 40 in this embodiment, has the configuration as shown in FIG. 13 which may be fabricated by stamping it on a singe sheet material such as cardboard or corrugated board. It has a central panel 41, two generally triangular shape side panels 42 and 43 joined to the central panel 41 by vertical fold lines 44 and 45 respectively, and a generally rectangular top panel 46 joined to the central panel 41 by horizontal fold line 47. Two L-shaped mounting hooks 48 and 49 are formed at the upper free corners of the side panels 42 and 43 respectively and abutment tabs 50 and 51 are formed at its lower free corners. A horizontal tab 52 is formed at the upper free edge of the top panel 46. Vertical mounting openings 52 and 53 are formed adjacent to the left edge of the display stand front panel 15 and vertical mounting openings 54 and 55 are formed adjacent to the right edge similarly as shown in FIG. 12 for mounting the pedestal 40. The pedestal may be formed and mounted to the display stand by first folding the side panels 42 and 43 rearwards to the position perpendicular to the front panel 41 and then slidably inserting the mounting hooks 48 and 49 into the vertical mounting openings 52 and 54 respectively while urging the pedestal towards the front panel 15. The mounting tabs 50 and 51 will engage with the mounting openings 53 and 54 respectively such that the mounting hooks 48 and 49 will latch to the upper edge portion of the mounting openings 52 and 54 while the abutment tabs 50 and 51 will fully engage within the lower mounting openings 53 and 55 with their lower edge resting against the lower edge of the mounting openings 53 and 55. In this manner, the pedestal 40 is firmly mounted to the display stand 16. The top panel 46 may then be turned rearwards until its horizontal tab 52 engages with the horizontal mounting opening 56 formed on the front panel 15 of the display stand to form the horizontal platform of the pedestal 40 for supporting the merchandise display case at the raised position above the floor. Due to the rearwardly slanted front panel 15, the center of gravity of the merchandise display case together with the merchandise items located therein will lie within the base of the displace stand so that the weight will maintain the display stand upright firmly to provide the increased stability.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1-3. (canceled)

4. A stabilizing pedestal mountable to a base portion of a front panel of display stand for supporting a display case placed thereon, comprising:
a foldable pattern formed on a sheet material, said pattern having a central panel and two side panels extending from two side edges of said central panel, each one of said side panels being foldable relative to said central panel along a vertical fold line,
a mounting hook formed at an outer edge of each one of said side panels, said outer edge being free edge distal from said vertical fold line, said mounting hook being engageable with a vertical mounting slot opening formed adjacent to one side of said front panel of said display stand,
a generally rectangular panel located above said central panel and foldable relative to said central panel along a horizontal fold line,
a mounting tab formed at a top edge of said rectangular panel, said mounting tab being engageable with a horizontal mounting slot opening formed in said front panel of said display stand to retain said rectangular panel in a horizontal mounted position,
said mounting hook having a reverse L-shaped including a downwardly extending arm portion engageable with a lower edge portion of said vertical mounting slot opening of said front panel of the display stand for detachably mounting said pedestal to said front panel,
said extension arm portion being foldable to lie juxtaposed to said mounting hook prior to being inserted into said vertical mounting slot opening whereby said extension arm portion inherently unfolds after insertion for retaining said pedestal permanently and securely to said display stand,
an additional vertical fold line formed at a middle location of each one of said side panels whereby said pedestal is foldable to a collapsed condition by folding said side panels along said vertical fold line.

5. A stabilizing pedestal according to claim 4 wherein said mounting hook of each side panel is spaced at a distance from a bottom edge of said central panel equal to the distance between said vertical mounting slot opening and a bottom edge of said front panel of the display stand.

6. A stabilizing pedestal according to claim 5 wherein said front panel of said display stand is slanted rearward at a top portion therein.

7. A stabilizing pedestal according to claim 6 wherein said foldable pattern is formed on a sheet material selected from the group including cardboard and corrugated board.

8. A stabilizing pedestal according to claim 6 wherein said mounting hooks are butterfly shaped.

9. A stabilizing pedestal mountable to a base portion of a front panel of a display stand for supporting a merchandise display case placed thereon, comprising:
a foldable pattern formed on a sheet material, said pattern having a central panel and two side panels extending from two vertical side edges of said central panel, each one of said side panels being foldable relative to said central panel along said side edges of said central panel,
a mounting hook and a generally rectangular abutment tab formed at an outer edge of each one of said side panels, said outer edge being a free edge distal from said side edges of said central panel, said mounting hook and said rectangular abutment tab being engageable with a pair of vertical mounting slot openings formed adjacent to one side edge of said base portion of said front panel of the display stand,
a generally rectangular panel located above said central panel and having a common edge with said central panel, said rectangular panel being foldable relative to said central panel,
a mounting tab formed at a top free edge of said rectangular panel, said mounting tab being engageable with a horizontal mounting slot opening formed in said front panel of said display stand for retaining said rectangular panel in a horizontal position and forming a platform on said front panel of said display stand for supporting a merchandise display case at a raised position on said front panel.

10. A stabilizing pedestal according to claim 9 wherein said mounting hook is spaced from said rectangular abutment tab.

11. A stabilizing pedestal according to claim 10 wherein said mounting hook has an L shape.
